(19) United States
(12) Patent Application Publication
(10) Pub. No.: US 2014/0235917 A1
(43) Pub. Date: Aug. 21, 2014

(54) PHARMACEUTICAL DISPOSAL DEVICE AND METHOD

(71) Applicant: Combined Distributors, Inc., Toms River, NJ (US)

(72) Inventor: David William Best, North Yorkshire (GB)

(73) Assignee: Combined Distributors, Inc., Toms River, NJ (US)

(21) Appl. No.: 14/185,545

(22) Filed: Feb. 20, 2014

Related U.S. Application Data
(60) Provisional application No. 61/766,967, filed on Feb. 20, 2013.

(51) Int. Cl. B09B 3/00

(52) U.S. Cl. CPC B09B 3/0075; B09B 3/0033
USPC 588/259; 206/204; 252/365

(57) ABSTRACT

A device for disposing unused pharmaceuticals including a container having sealing means, a superabsorbent polymer arranged in the container in a loose orientation, a deterrent compound, and optionally a dye. The device is adapted so that after pharmaceuticals and a fluid substance are added to the container, and the container is sealed, the container can be agitated (e.g., shaken) to enable the superabsorbent polymer to absorb the fluid and congeal in order to nearly instantaneously form a gel structure, which completely or nearly completely envelops the pharmaceuticals in the container. The deterrent compound can break down and/or denature the pharmaceuticals enveloped in the gel structure. The container may then be disposed of in a conventional household garbage container. The dye provides a visual warning that the pharmaceuticals should not be consumed and the repellant compound provides an unpleasant flavor and/or smell which deters ingestion of the pharmaceuticals.

### CROSS-REFERENCE TO RELATED APPLICATIONS

This application claims priority to U.S. Provisional Patent Application Ser. No. 61/766,967, filed Feb. 20, 2013, the entire disclosure of which is hereby expressly incorporated by reference herein.

### FIELD OF THE INVENTION

This invention relates to devices for disposal of pharmaceuticals and methods therefor.

### BACKGROUND OF THE INVENTION

The use of pharmaceuticals for medicinal purposes is widespread and is expected to increase as the population ages and life expectancy increases. The disposal of unused pharmaceuticals by patients in their home trash and/or by being flushed down the toilet poses significant environmental problems. Pharmaceuticals that are disposed of in these or similar ways may end up in the local water supply, thus posing a threat to the surrounding population, wildlife, and vegetation. Disposing of pharmaceuticals in a household garbage container also poses the risk of accidental poisoning, misuse, and theft.

In order to reduce these risks, certain government agencies provide guidelines and/or impose restrictions on disposing pharmaceuticals in household garbage containers or provide guidelines for safe disposal of pharmaceuticals. For instance, the Environmental Protection Agency recommends that consumers refrain from flushing unused pharmaceuticals down the toilet, and instead remove the pharmaceuticals from their original containers and mix them with an undesirable substance such as cat litter and/or coffee grinds. The Environmental Protection Agency recommends that the mixture then be placed into a sealable bag or container and disposed of in the garbage.

Accordingly, it is an aspect of the present invention to provide a device for disposal of unused pharmaceuticals that envelops the pharmaceutical in a congealed gel substance and renders the pharmaceuticals unusable.

Yet another aspect of the present invention is a composition for disposing of unused pharmaceuticals.

Still a further aspect of the present invention is a method for disposing of unused pharmaceuticals by enveloping the pharmaceuticals in a congealed gel substance within a sealed container and rending the pharmaceuticals unusable.

### SUMMARY OF THE INVENTION

The present invention is directed to a device for disposing unused pharmaceuticals. The device comprises a container having sealing means. The device contains a superabsorbent polymer, a deterrent composition, and optionally a dye, and is adapted to receive an amount of unused pharmaceuticals for disposal. A mixture comprising the superabsorbent polymer, the deterrent composition, and/or the dye is optionally arranged in the container in a loose (unbound) orientation, and the pharmaceuticals are deposited to the container. The device is adapted so that when a fluid substance is added to the container and the container is sealed, agitating the container (e.g., by shaking) enables the superabsorbent polymer to absorb the fluid and congeal in order to nearly instantaneously form a gel structure which completely or nearly completely envelops the pharmaceuticals that have been deposited in the container. Additionally, the deterrent composition can render the pharmaceuticals unusable by breaking down the pharmaceuticals and/or making them undesirable. The container may then be disposed of in a conventional household garbage container with minimal risk of the pharmaceuticals being released into the environment. The dye provides a visual warning that the pharmaceuticals should not be consumed and the deterrent compound can provide an unpleasant odor and/or flavor which further deters ingestion of the pharmaceuticals.

The invention is also directed to a method for disposing unused pharmaceuticals and a composition for facilitating the safe disposal of unused pharmaceuticals.

### BRIEF DESCRIPTION OF THE DRAWING FIGURE

FIG. 1 is a schematic view of a device (container) for disposing unused pharmaceuticals in accordance with the present invention.

### DETAILED DESCRIPTION OF THE INVENTION

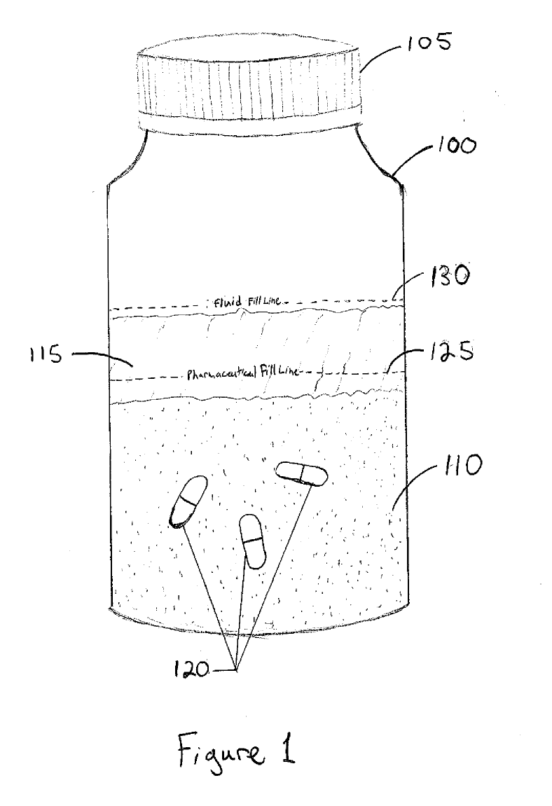

The present invention is directed to a device for disposing unused pharmaceuticals. Turning to FIG. 1, the device comprises a container 100 having sealing means 105.

In accordance with embodiments of the invention, container 100 includes a preventative mixture 110. Preventative mixture 110 can include, for example, a superabsorbent polymer. In one or more embodiments, the superabsorbent polymer can be, for example, sodium polyacrylate. Preventative mixture 110 can be arranged in a loose (unbound) orientation. The superabsorbent polymer included in preventative mixture 110 is adapted to quickly expand and congeal when in the presence of a fluid 115 in order to create a gel structure (not shown) which envelops unused pharmaceuticals which have been deposited therein, such as, for example, pill capsules 120. The amount of the superabsorbent polymer in container 100 is an amount sufficient to form a gel when fluid 115 is added to container 100.

In accordance with embodiments of the invention, a deterrent compound is included in preventative mixture 110 within container 100. In an embodiment, this deterrent compound comprises calcium hypochlorite. Calcium hypochlorite can aid in breaking down a pharmaceutical to allow for active ingredients to be more readily absorbed and/or disposed of. In some embodiments, such as is the case with calcium hypochlorite, the deterrent compound can have a repugnant smell and/or a bitter or otherwise unpleasant taste, to further aid in deterring one from desiring to access the pharmaceuticals enveloped in the gel structure of the superabsorbent polymer. Additionally or alternatively, other deterrent compounds can be included in preventative mixture 110, such as, for example, denatonium benzoate, which is known to provide a bitter taste when ingested. The amount of the deterrent compound is an amount sufficient to repel and/or deter a human or animal from seeking to ingest the pharmaceutical (e.g., capsule pills 120).

In accordance with further embodiments of the invention, preventative mixture 110 of the device can optionally include a dye, such as a food grade dye stuff. The amount of the dye is an amount sufficient to impart an easily observable color to the congealed gel structure which forms when the fluid is added to the container.

Preventative mixture 110 can also include other materials to aid in the breakdown and/or absorption of pharmaceuticals. For example, in accordance with embodiments of the invention, Fuller's earth comprising attapulgite or bentonite can be included in preventative mixture 110 to aid in the disposal process. Fuller's earth can soak up active ingredients which have been extracted from the unused pharmaceuticals, thus making the active part of the pharmaceuticals irretrievable. Fuller's earth has the added benefit of providing a natural dye.

The container 100 is adapted to hold an amount of fluid 115, which can be water or any other aqueous solution. In accordance with various embodiments of the invention, the user operates the device by first removing or otherwise opening sealing means 105, placing one or more pharmaceuticals and an amount of fluid 115 into container 100 come into contact with preventative mixture 110, and replacing or otherwise resealing sealing means 105. Optionally, prior to opening the sealing means 105, container 100 can be shaken or otherwise agitated preliminarily to better ensure that preventative mixture 110 will quickly come into contact with fluid 115 and the pharmaceuticals once they are added, and to aid in the congealing process. The user then shakes or otherwise agitates the loose preventative mixture 110 inside the container, and particularly the superabsorbent polymer, while the sealing means 105 is in a sealed orientation in order to disperse the preventative mixture 110 and prevent clumping. It will be obvious to one of ordinary skill in the relevant arts that unused pharmaceuticals may be in pill, liquid, powder, capsules, or other known forms or combinations thereof, and that capsule pills 120 are simply an example of such pharmaceuticals.

Optionally, embodiments of the device can include a first indicating means 125 for specifying an approximate maximum amount of pharmaceuticals that can be deposited in container 100 prior to fluid 115 being added. Likewise, the device can include a second indicating means 130, which can indicate the amount of fluid 115 to be added prior to container 100 being sealed. For example, the indicator means 125 and 130 can each comprise a line on a circumference of the container 100.

When the user shakes the sealed container 100 the superabsorbent polymer absorbs the fluid 115 and expands. The superabsorbent polymer also congeals when absorbing the fluid 115 and it nearly instantaneously forms a gel structure which completely or nearly completely envelops the pharmaceuticals in the container 100. Likewise, the deterrent compound can break down and/or denature the pharmaceuticals enveloped in the gel structure. The device is adapted to allow the user to efficiently and effectively dispose of the pharmaceuticals.

Another aspect of the invention is a method for disposing unused pharmaceuticals as described above. The method includes the step of shaking a sealed container 100 containing therein preventative mixture 110 having an effective amount of a superabsorbent polymer such as sodium polyacrylate arranged in the container 100 in a loose (unbound) orientation, an effective amount of a deterrent compound, such as calcium hypochlorite, and/or an effective amount of dye such as a food grade dye stuff. The compounds comprising preventative mixture 110 in the container 100 may be added separately by the user or may be pre-packaged within the container 100.

The user then places unused pharmaceuticals, such as pill capsules 120, in the container and then fills the container with a specified amount of fluid substance 115, such as water. The user then seals the container 100 using, for example, sealing means 105, to create an air tight and water tight seal, and shakes the container 100. When the user shakes the sealed container 100 the superabsorbent polymer within preventative mixture 110 absorbs the fluid 115 and expands. The superabsorbent polymer also congeals when absorbing the fluid 115 and it nearly instantaneously forms a gel structure which completely or nearly completely envelops the pharmaceuticals in the container 100. Likewise, the deterrent compound can break down and/or denature the pharmaceuticals enveloped in the gel structure. The device may be placed in an ordinary trash container for safe disposal.

A further aspect of this invention is a composition for the safe disposal of unused pharmaceuticals as described above. The composition comprises an effective amount of a superabsorbent polymer such as sodium polyacrylate, an effective amount of a deterrent compound, such as, for example, calcium hypochlorite, and optionally an effective amount of dye such as a food grade dye stuff. In some embodiments, preventative mixture 110 can comprise 88-96% superabsorbent polymer, 1-5% deterrent compound (e.g., calcium hypochlorite), and 3-7% dye and/or other absorbent compound (e.g., Fuller's earth). Of course, other effective combinations and amounts are also contemplated, and these percentages should therefore not be considered limiting.

What is claimed is:

1. A device comprising:
a container having sealing means;
an effective amount of a superabsorbent polymer in said container; and
an effective amount of calcium hypochlorite.

2. The device of claim 1 further comprising an effective amount of a dyestuff.

3. The device of claim 1 wherein the superabsorbent polymer is sodium polyacrylate.

4. A method for disposing unused pharmaceuticals comprising:
adding unused pharmaceuticals to a container having an effective amount of a superabsorbent and an effective amount of calcium hypochlorite;
adding an effective amount of fluid to the container; and
agitating the container in a sealed orientation to form a gel substance.

5. The method of claim 4 further comprising the steps of adding an effective amount of a foodgrade dyestuff.

6. The method of claim 4 wherein the superabsorbent polymer is sodium polyacrylate.

7. A composition for safely disposing unused pharmaceuticals comprising:
an effective amount of a superabsorbent polymer; and
an effective amount of calcium hypochlorite.

8. The composition of claim 7 wherein said composition further includes an effective amount of a foodgrade dyestuff.

9. The composition of claim 7 wherein the superabsorbent polymer is sodium polyacrylate.
